(19) United States
(12) Patent Application Publication
(10) Pub. No.: US 2024/0412301 A1
(43) Pub. Date: Dec. 12, 2024

(54) COLLABORATIVE NEXUS DEVICE FOR SOLVING CLIMATE CHANGE MITIGATION AND WATER SUSTAINABILITY AND SYSTEM INCLUDING THEREOF

(71) Applicant: The Hong Kong University of Science and Technology, Hong Kong (CN)

(72) Inventor: Mengqian LU, Hong Kong (CN)

(21) Appl. No.: 18/736,547

(22) Filed: Jun. 7, 2024

Related U.S. Application Data
(60) Provisional application No. 63/507,094, filed on Jun. 8, 2023.
(60) Provisional application No. 63/511,691, filed on Jul. 3, 2023.

(51) Int. Cl. G06Q 50/00; G01W 1/00

(52) U.S. Cl. CPC G06Q 50/01; G01W 1/00

(57) ABSTRACT

A collaborative nexus device for solving climate change mitigation and water sustainability. The device comprises a connecting port and a processor. The processor obtains at least one task data from a plurality of request ends and at least one candidate data from a plurality of bidding ends through the connecting port. The processor matches a plurality of items related to climate change mitigation and water sustainability of the candidate data with at least one of the task data. The processor providing a collaborative contract to the request end corresponded to the matched task data and the bidding end corresponded to the matched candidate data. The processor provides a collaborative space to both the matched request end and the matched bidding end. A system for collaborative nexus is also provided.

### FIELD OF THE INVENTION

The present invention generally relates to collaborative platform. More specifically the present invention relates to collaborative nexus device and system solving climate change mitigation and water sustainability.

### BACKGROUND OF THE INVENTION

There is a call for innovation in addressing challenges in climate change and water sustainability. Numerous companies and research labs grapple with challenges related to climate change and water sustainability that surpass the capacities of their existing facilities. These challenges are often compounded by limited resources, including funding and data, as well as prolonged cycles for research grant applications.

Though the companies, research labs, and government are fighting for the same target, there are barriers to collaboration. The collection of comprehensive water resources data for any given region proves challenging, further exacerbated by entities possessing only partial data being hesitant to share and collaborate. The absence of incentives for cooperation hinders the resolution of critical climate and water-related issues, leading to persistent problems or delays in finding solutions.

Also, in these entities, there are underutilized resources. In some instances, organizations resort to costly project-based consultants to address these challenges, resulting in a suboptimal utilization of valuable talents within institutions. Limited access to resources further restricts the potential impact of these talents.

Aligning climate and water-related challenges with the right talents and resources can significantly enhance the effectiveness of both companies and non-governmental organizations (NGOs). This alignment not only accelerates scientific discoveries but also maximizes the value derived from data.

The current landscape sees climate and water challenges being addressed through expensive consulting engagements, presenting an opportunity for a more efficient and economical solution. The absence of a comprehensive solution in the market highlights a significant opportunity for innovation. Similar entities and companies, such as As You Sow, Blue Green Alliance, and Southern Environment Law Center, underscore the need for a transformative approach.

While many initiatives traditionally involve the accumulation of resources and network building over several years, the urgency of contemporary climate and water issues demands a more expedited approach. Spending decades to establish foundations for each committed organization may result in problems accumulating faster than solutions can be developed.

Long-standing partnerships between government, scientists, and private sectors, often revolving around government-funded research projects and co-investments in technology-transferable innovations, have proven valuable. However, the existing lengthy application, vetting, and initiation cycles may not align with the urgent nature of contemporary climate and water challenges. A new approach and method are imperative in our current era marked by imminent threats from climate change and water scarcity.

### SUMMARY OF THE INVENTION

It is an objective of the present invention to provide a device, a method and a system to address the aforementioned shortcomings and unmet needs in the current state of the art. The present invention provides a collaborative nexus device that can solve climate change mitigation and water sustainability, and a system that can be utilize with request ends operated by entities having request and bidding ends operated by talents.

The present invention is an upgraded technology platform, i.e. a web-based collaborative platform, designed to connect the previously mentioned efforts in water sustainability and climate change problem-solving with the right talents, resources, and data. It operates as an all-in-one service environment for initiating such tasks, encompassing features like data collection and security, funding pooling, talent search and matching, and task management.

The present invention provides a comprehensive platform with incentives and mechanisms aimed at expediting the resolution of climate and water-related challenges. By addressing the common limitations of resources and data that often impede the initiation and progress of solutions, this platform offers a streamlined approach to problem-solving.

In accordance with a first aspect of the present invention, a method for collaborative nexus for solving climate change mitigation and water sustainability is provided. The method comprises: obtaining at least one task data from a plurality of request ends and at least one candidate data from a plurality of bidding ends; matching a plurality of items related to climate change mitigation and water sustainability of the candidate data with at least one of the task data; providing a collaborative contract to the request end corresponded to the matched task data and the bidding end corresponded to the matched candidate data; and providing a collaborative space to both the matched request end and the matched bidding end.

In accordance with a second aspect of the present invention, a collaborative nexus device for solving climate change mitigation and water sustainability is provided. The device comprises a connecting port and a processor. The connecting port is connected to a plurality of request ends and a plurality of bidding ends. The processor is connected to the connecting port. The processor obtains at least one task data from the request ends and at least one candidate data from the bidding ends through the connecting port. The items of the task data include data insights, and the candidate data includes items about skills possessed by an individual or a group of people, and the processor matches these items. The items are related to climate change mitigation and water sustainability. The processor provides a collaborative contract to the request end corresponded to the matched task data and the bidding end corresponded to the matched candidate data through the connecting port, and display the collaborative contract on the request end and the bidding end and ask for signatures. The processor provides a collaborative space to both the matched request end and the matched bidding end, and the both ends display the collaborative space showing information about progress of a task generated from the task data and interface for both input and output.

In accordance with a third aspect of the present invention, a system for solving climate change mitigation and water sustainability is provided. The system comprises the device, the request ends, and the bidding ends, and the device comprises a matching platform and the collaborative space. The collaborative nexus device is connected to the request ends and the bidding ends through internet. The matching platform displays interfaces for input on the request ends and the bidding ends individually. The collaborative nexus device obtains the task data and the candidate data through the interfaces of the matching platform. The matching platform matches the items related to climate change mitigation and water sustainability of the task data with the candidate data, and the matching platform provides the collaborative contract. The collaborative nexus device provides the collaborative space to both the matched request end and the matched bidding end.

In accordance with one embodiment of the present invention, the items related to climate change mitigation and water sustainability comprises: a plurality of analyses of renewable energy as climate changes; and an analyzing duration; and a required deadline, and the analyses comprise availability of renewable energy.

In accordance with another embodiment, the items related to climate change mitigation and water sustainability comprises: a plurality of analyses of earth systems; a plurality of related decision-makings as climate evolves; an analyzing duration; a required deadline, and a quality requirement of the analyses targets/results.

In accordance with another embodiment, the items related to climate change mitigation and water sustainability comprises: a plurality of river flow data collections of varied locations; and at least one requirement related to river flow data collection.

In accordance with another embodiment, the items related to climate change mitigation and water sustainability comprises: at least one visualizing format; at least one visualizing style; and at least one language.

In accordance with another embodiment, the items related to climate change mitigation and water sustainability comprises: at least one carbon footprint analysis method; and at least one analysis equipment.

In accordance with another embodiment, the items related to climate change mitigation and water sustainability comprises: at least one fintech domain; and at least one required fund.

In accordance with another embodiment, the items related to climate change mitigation and water sustainability comprises: at least one weather prediction period; and at least one weather prediction location.

In accordance with another embodiment, the collaborative space comprises: a task management interface.

In accordance with another embodiment, the collaborative space comprises a data security and protection.

In accordance with another embodiment, the collaborative space comprises a quality control and dispute interface.

In summary, the device and system for collaborative nexus for solving climate change mitigation and water sustainability provide an efficient platform for collaboration between entities and specialist, and the entities may include companies, research labs, or government, while the specialists are expert in varied domain related to Earth science and environmental science/engineering.

### BRIEF DESCRIPTION OF THE DRAWINGS

Embodiments of the invention are described in more details hereinafter with reference to the drawings, in which:

FIG. 1 depicts a schematic view of a system of collaborative nexus for solving climate change mitigation and water sustainability in accordance with an embodiment of the present invention;

FIG. 2 depicts another schematic view of a system of collaborative nexus for solving climate change mitigation and water sustainability in accordance with the embodiment of the present invention;

FIG. 3 depicts another schematic view of a system of collaborative nexus for solving climate change mitigation and water sustainability in accordance with the embodiment of the present invention;

FIG. 4 depicts another schematic view of a system of collaborative nexus for solving climate change mitigation and water sustainability in accordance with an embodiment of the present invention; and

FIG. 5 depicts another schematic view of a system of collaborative nexus for solving climate change mitigation and water sustainability in accordance with an embodiment of the present invention.

### DETAILED DESCRIPTION

In the following description, devices and systems for collaborative nexus for solving climate change mitigation and water sustainability and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

In accordance with a first aspect of the present invention, a device for collaborative nexus for solving climate change mitigation and water sustainability is provided. The device presents a platform that can be deployed on request ends and bidding ends such as computers, laptops, or smart phones.

The method includes the following procedures: obtaining task data and candidate data; matching the data; and setting up a collaborative space.

However, the method is not limited to these procedures. The following will provide a well-illustrated detailed description of this method.

The steps of the method of this embodiment include obtaining at least one task data from a plurality of request ends and at least one candidate data from a plurality of bidding ends.

In this embodiment, the request ends can be devices operated by entities such as companies, research labs, or government, and the bidding ends can be devices operated by specialists, or scientists. These devices can include computers, laptop, and smart phones.

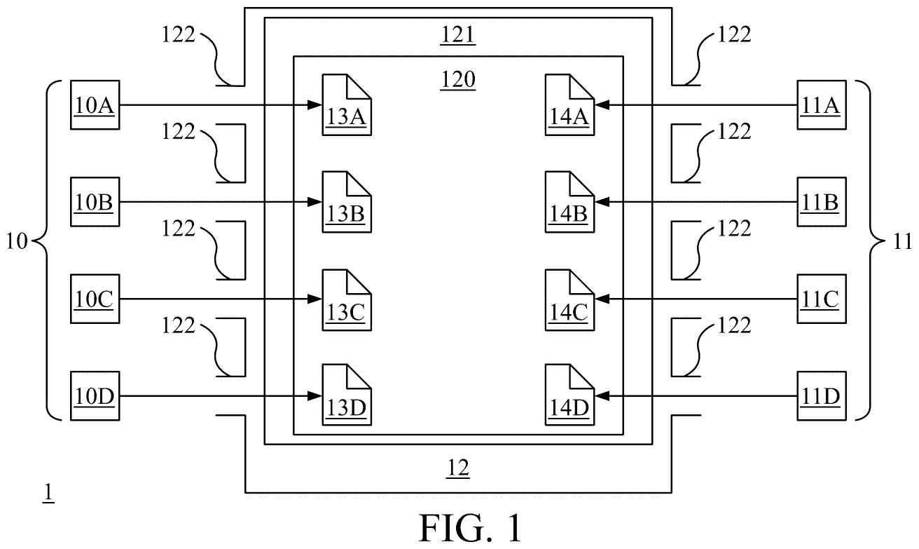

FIG. 1 depicts a schematic view of a system of collaborative nexus for solving climate change mitigation and water sustainability in accordance with this embodiment of the present invention, and both the method, the device and system of this embodiment will be illustrated through the following description. Referring to FIG. 1, in this step of the method of this embodiment, task data 13A, 13B, 13C, 13D are obtained from the request ends 10, and candidate data 14A, 14B, 14C, 14D are obtained from the bidding ends 11.

To be specific, in the system 1, a collaborative nexus device 12 has a processor 121 and connecting ports 122. The connecting ports 122 are connected to the request ends 10 and the bidding ends. The processor 121 is connected to the connecting ports 122.

The processor 121 obtains the task data 13A, 13B, 13C, 13D, and the candidate data 14A, 14B, 14C, 14D, and the processor 121 matches the data.

To be specific, the collaborative nexus device 12 provides a matching platform 120 through the processor 121, and the collaborative nexus device 12 obtains the task data 13A, 13B, 13C, 13D and the candidate data 14A, 14B, 14C, 14D through the matching platform 120. The matching platform 120 can be present in a web-page form or an application interface in request ends 10 and the bidding ends 11 for input. The matching platform 120 provides interfaces to the request ends 10 that are different from the interfaces received by the bidding ends 11, so the interfaces provided to the request ends 10 are specially designed for entities such as companies, research labs, or government that has task related to climate change or water sustainability, and the interfaces provided to the bidding ends 11 are specially designed for specialists and scientist that are expert in domain related to climate change or water sustainability. For example, the interfaces provided to the request ends 10 have an online interactive questionnaire, and the questionnaire aims to assist and effective and efficient drafting of a task that specifies the skill sets, level of experiences and additional options including language.

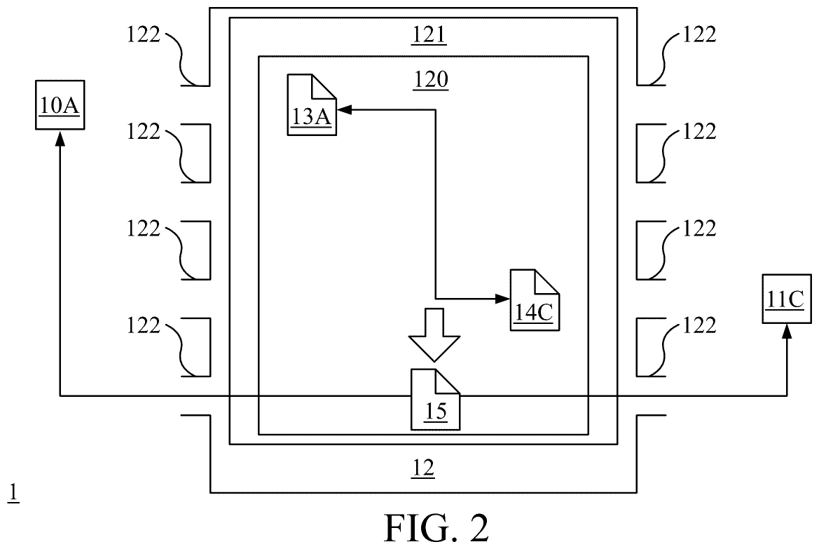

After the task data 13A, 13B, 13C, 13D and the candidate data 14A, 14B, 14C, 14D are obtained, the device 12 of this embodiment matches the items related to climate change mitigation and water sustainability of the candidate data with at least one of the task data. Referring to FIG. 2, in this embodiment for example, the request end 10A provides the task data 13A, and the bidding end 11C provides the candidate data 14C, and their items match. According to the matched items, the matching platform 120 matches the candidate data 14C and the task data 13A.

To be specific, the items of the candidate data 14C are related to climate change mitigation and water sustainability, and the items include specialties, categories of task, or fee for services. The items of the task data 13A are also related to climate change mitigation and water sustainability, and the items include requirement, budget, or period of task. The items of the task data 13A related to a task, and the items of the candidate data 14C meet the needs of the task when they are matched.

After the candidate data 14C and the task data 13A are match, the processor 121 provides a collaborative contract 15 to the request end 10A corresponded to the matched task data 13A and the bidding end 11C corresponded to the matched candidate data 14C. The matching platform 120 generates the collaborative contract 15 according to user information from the task data 13A and the candidate data 14C, and the device 12 provides a contract signing services through generating and providing the collaborative contract 15 to the request end 10A and the bidding end 11C, and the data of the collaborative contract 15 is encrypted before it is sent, and the data security is improved.

For example, the collaborative nexus device 12 will received the task data 13A and the candidate data 14C, and outputting a collaboration contract according to the information in these data. In other words, the collaborative nexus device 12 generate the collaboration contract according to the items in the task data 13A and the candidate data 14C. In some embodiments, the collaborative nexus device 12 calibrate or learn the items from the task data 13A and candidate data 14C, so as to generated the collaboration contract automatically, and the collaborative nexus device 12 improve the efficiency of the contract generation of the system 1.

Through the connecting ports 122, the processor 121 provides and displays the collaborative contract on the request end 10A and the bidding end 11C and ask for signatures.

After the collaborative contact 15 is signed and collected by the matching platform 120, the collaborative nexus device 12 of the system 1 of this embodiment modifies a collaborative space 130 according to the task data 13A and the candidate data 14A through the processor 121, and the collaborative space 130 is provided to both the matched request end 10A and the matched bidding end 11C.

In some embodiments of the present invention, the collaborative space is a web-based platform that can provide interfaces to the bidding ends and the request ends through webpages or applications.

In this embodiment referring to the drawings, the collaborative space 130 provide functions and interfaces related to execution of the task on both the request end 10A and the bidding end 11C. The both request end 10A and the bidding end 11C display the collaborative space 130 showing information about progress of the task generated from the task data 13A and interface for both input and output. The functions include funding pooling, data collection, task management, resources dispatch, patent citations, quality control, and dispute resolution, and the data is encrypted before it is sent.

The device 12 of the embodiment can be a server and provide a web-based platform for matching and syncing between tasks and specialists, which can accelerate the progress of tasks related to climate change mitigation and water sustainability, and it operates as an all-in-one service environment for initiating such task.

The device and the system of the embodiment provide different services to the request ends and the bidding ends. To be specific, the method and the collaborative nexus device 12 provide a plurality of memberships. The various memberships include government, scientists, and private sectors. Each membership is established and maintained with contribution, and the contribution include resources, data, or both. Therefore, the system and the device are suitable to most of the participants in climate change mitigation and water sustainability domain.

To be specific, in some embodiments, the memberships have different rankings. By uploading or providing more valuable resources or data, the membership acquires more credits, and their ranking will be higher. The priority of the matching process will be based on the ranking of the membership of the request end or bidding end.

In some other embodiment, the memberships' ranking includes standard ranking and professional ranking. The request ends and the bidding ends with the standard ranking can apply for normal matching function. For the bidding end or the request end with the professional ranking, the collaborative nexus device further provides matching service with top priority, valuable data access, and latest cloud computing services.

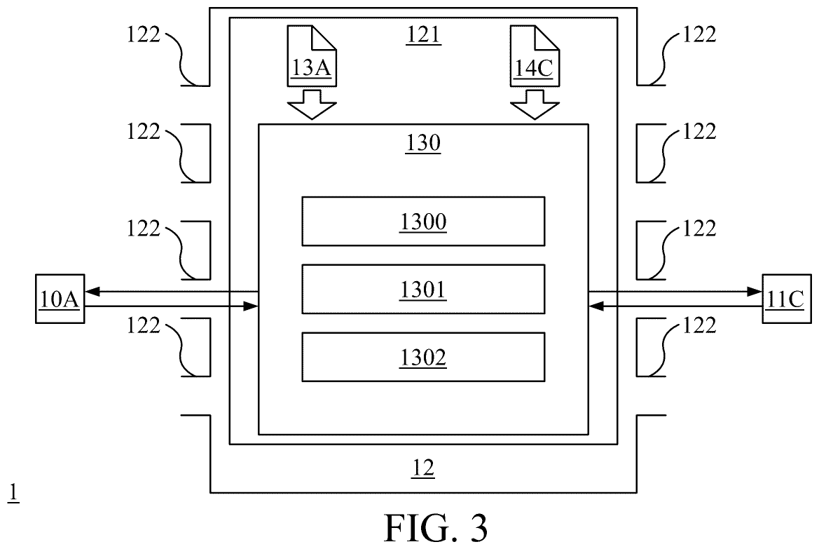

Referring to FIG. 3, the collaborative space 130 of this embodiment comprises a task management interface 1300. The task management interface 1300 is accessible to both the request end 10A and the bidding end 11C, and the collaborative space 130 provides different permission to the request end 10A and the bidding end 11C. Therefore, the collaborative space 130 can provide a comprehensive task management function. Furthermore, the task management interface 1300 also provides resources dispatching. The task management interface 1300 may provide views include timeline, calendar, or spreadsheets. Therefore, the users can streamline the entire process from task creation to completion with a single platform. This reduces the need to switch between multiple tools or systems, saving time and effort.

In this embodiment, the collaborative space 130 comprises a data security and protection 1301. The data security and protection 1301 provides encryption function to every data uploaded, created, or combined on the collaborative space 130. The users can apply different encryption on different documents, data transmission, and an administrator of the collaborative space 130 can assign different permission to different users, so as to improve the security.

In this embodiment, the collaborative space 130 comprises a quality control and dispute interface 1302. The quality control and dispute interface 1302 allows user to conduct thorough inspections and reviews of content, products, or services to ensure they meet predefined quality standards. In some embodiments, the interface 1302 can perform manual inspections or implement automated checks.

The interface 1302 also supports the implementation of quality assurance processes to verify that standards are being met consistently. Functions of the interface 1302 includes setting up workflows, checklists, or guidelines for assessing quality and ensuring compliance with relevant regulations or standards.

Also, users are available to provide feedback on the quality of the content, products, or services within the platform. Additionally, the space 130 should facilitate the correction of any identified issues or deficiencies through corrective actions or revisions.

The quality control function is seamlessly integrated with other components of the system 1. This ensures that quality control processes are aligned with overall business operations and objectives.

The interface 1302 provide a structured process for mediating and negotiating disputes between parties involved. The process involves facilitating communication between parties, clarifying issues, and exploring potential solutions to reach a mutually acceptable resolution.

In some embodiments, the collaborative space 130 includes other interfaces related to funding pooling, data collection, task management, resources dispatch, patent citations, quality control, and dispute resolution. In some other embodiments the collaborative space 130 include at least one of the interfaces 1300, 1301, 1302 above, and the user or administrator is available to modify the interfaces and functions of the collaborative space 130 according to the characteristics of the task and requirement.

The following description will illustrate the system and the device in varied embodiments, and the systems and devices in these embodiments can include any of the collaborative space 130 above.

In some embodiments of the present invention, the device and the system provide an interactive questionnaire to the request ends, so the request ends generate task data efficiently. The items of every task data include clear task descriptions, which will be describe in different embodiments, and the items of the task data can be modified, added, removed based on the requirement of the tasks.

In an embodiment, the items related to climate change mitigation and water sustainability comprises: a plurality of analyses of renewable energy as climate changes, an analyzing duration, and a required deadline. The analyses comprise availability of different renewable energy.

To be specific, if the request end 10A is operated by a company, which is the task initiator, needs an analysis of future availability of hydropower versus other forms of renewable energy as climate continues to warm up, the company can choose the analyses according to the renewable energy under their consideration. The company can input the period they're interested in into the analyzing duration. Also, the company can input the required deadline if needed. All this information is acquired from the company through the interactive questionnaire and included in the task data 13A.

In other words, the items related to climate change mitigation and water sustainability at least comprise analyses whose targets or results address inquiries from the task initiator, and the analyses potentially support decision-making.

On the other hand, the bidding end 11C is operated by a specialist in renewable energy analyzing. The specialist can input the kind of renewable energy he/she is specialized in i.e. analyses of renewable energy as climate changes, the duration of analyzing he/she can provide i.e. analyzing duration, and the available timeslot i.e. required deadline through the questionnaire for the bidding end 11C. Therefore, the candidate data 14C also has the analyses of renewable energy as climate changes, analyzing duration, and require deadline, and the matching platform 120 matches the task data 13A and the candidate data 14C according to these items. Therefore, the device and system of this embodiment can fulfil task related to renewable energy.

In another embodiment, the items related to climate change mitigation and water sustainability comprises: a plurality of analyses of earth systems; a plurality of related decision-makings as climate evolves; an analyzing duration; a required deadline; and a quality requirement of the targets or results of the analyses.

To be specific, if the request end 10A is operated by a task initiator who needs analyses of earth system, the task initiator can input the kind of analyses their needs. For more details, the task initiator may also input the duration, the deadline, or the quality requirement of the analyses. If the task initiator needs consultancy, they can also input their decision-making process.

On the other hand, the bidding end 11C is operated by a specialist in earth system or climate evolution. The specialist can input the kind of analyses he/she is specialized in i.e. analyses of earth system, technical area of consultancy i.e., the decision-makings as climate evolves, the quality he/she can provide, the duration of analyzing he/she can provide, and the available timeslot through the questionnaire for the bidding end 11C. Therefore, the candidate data 14C also has the analyses of earth system, the decision-makings as climate evolves, the analyzing duration, the required deadline, and the quality requirement, and the matching platform 120 matches the task data 13A and the candidate data 14C according to these items. Therefore, the method and system of this embodiment can fulfil task related to earth system and climate evolution.

In another embodiment, the items related to climate change mitigation and water sustainability comprises: a plurality of river flow data collections of varied locations, and at least one requirement related to river flow data collection.

To be specific, if the request end 10A is operated by a company collects river flow data in different locations, and the company wants to filter the data based on its locations, the company can choose the river flow data collection of varied locations as their unfiltered data, and the requirement that is under their consideration as their parameter of filter. All this information is acquired from the company through the interactive questionnaire and included in the task data 13A.

On the other hand, the bidding end 11C is operated by a specialist in river flow data collection. The specialist can input the area where he is specialized in i.e. the river flow data collections of varied locations, and the parameter he/she can gather during the collections i.e., requirement related to river flow data collection. Therefore, the candidate data 14C also has the river flow data collections of varied locations and requirement related to river flow data collection, and the matching platform 120 matches the task data 13A and the candidate data 14C according to these items. Therefore, the device and system of this embodiment can fulfil task related to river flow data.

In another embodiment, the items related to climate change mitigation and water sustainability comprises: at least one visualizing format, at least one visualizing style, and at least one language.

To be specific, if the request end 10A is operated by an organization wanted to convert their data in any visual art for education, the organization can choose the file format they needed in visualizing format, and the organization can choose the visualizing style, and the language they wish to use if any annotation is added. All this information is acquired from the organization through the interactive questionnaire and included in the task data 13A.

On the other hand, the bidding end 11C is operated by an environment artist knows how to convert data into visual art. The artist can input the file format he/she can provide i.e. visualizing format, the style he/she is specialized in i.e. visualizing style, and the language he/she can use. Therefore, the candidate data 14C also has the visualizing format, the visualizing style, and the language, and the matching platform 120 matches the task data 13A and the candidate data 14C according to these items. Therefore, the device and system of this embodiment can fulfil task related to environmental data visualization.

In another embodiment, the items related to climate change mitigation and water sustainability comprises: at least one carbon footprint analysis method, and at least one analysis equipment.

To be specific, if the request end 10A is operated by a company with resources and equipment for data collection or data, the company can input carbon footprint analysis method they need and the analysis equipment they can provided. All this information is acquired from the company through the interactive questionnaire and included in the task data 13A.

On the other hand, the bidding end 11C is operated by an expert in carbon footprint analysis using approach such as isotope. The expert can input the carbon footprint analysis method he/she can provide, and the analysis equipment he/she is specialized in. Therefore, the candidate data 14C also has the carbon footprint analysis method and the analysis equipment, and the matching platform 120 matches the task data 13A and the candidate data 14C according to these items. Therefore, the device and system of this embodiment can fulfill task related to carbon footprint analysis.

In another embodiment, the items related to climate change mitigation and water sustainability comprises: at least one fintech domain, and at least one required fund.

To be specific, the request end 10A is operated by a small hedge fund wants to develop a strategy for Environmental, Social, and Corporate Governance (ESG) fund. The hedge fund can input the fintech domain they required and the kind of fund under their consideration. All this information is acquired from the hedge fund through the interactive questionnaire and included in the task data 13A.

On the other hand, the bidding end 11C is operated by a fintech expert has domain specific expertise in financial engineering and green energy. The expert can input the domain and the kind of fund he/she is familiar with i.e. required fund through the questionnaire for the bidding end 11C. Therefore, the candidate data 14C also has the fintech domain and the required fund, and the matching platform 120 matches the task data 13A and the candidate data 14C according to these items. Therefore, the device and system of this embodiment can fulfill task related to fund raising.

In another embodiment, the items related to climate change mitigation and water sustainability comprises: at least one weather prediction period, and at least one weather prediction location.

To be specific, if the request end 10A is operated by a farmer want to decide whether to idle or recover their land in the coming season with government support, the farmer can input the weather prediction period and location. All this information is acquired from the farmer through the interactive questionnaire and included in the task data 13A.

On the other hands, the bidding end 11C is operated by a meteorologist has domain specific expertise in weather prediction. The meteorologist can input the weather prediction period and location he/she is willing to provide. Therefore, the candidate data 14C also has the weather prediction period and the weather prediction location, and the matching platform 120 matches the task data 13A and the candidate data 14C according to these items. Therefore, the device and system of this embodiment can fulfil task related to weather prediction.

In some embodiments of the present invention, the matching step includes a bid mode and an invite mode. In the bid mode, the matching platform collects the task descriptions using the online interactive questionnaire and provide a list of recommended specialists according to the task descriptions.

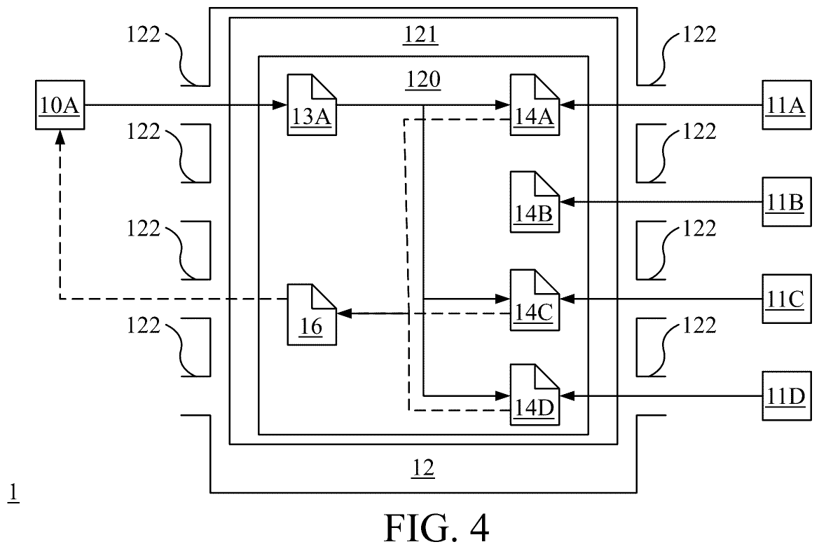

Referring to FIG. 4, in the bid mode, the matching platform 120 obtain the task data 13A through the questionnaire. According to the task data 13A, the matching platform 120 chooses the candidate data 14A, 14C, 14D obtained from the bidding ends 11A, 11C, 11D respectively without choosing the candidate data 14B from the bidding end 11B. Then, the matching platform 120 generates a list of recommended candidates 16 according to the chosen candidate data 14A, 14C, 14D. The list 16 is provided to the request end 10A, and the user of the request end 10A can choose to award the task to one of the users corresponded to the candidate data 14A, 14C, 14D. In other words, the matching platform 120 curates a bid based on capabilities and past experiences of the specialists, so as to improve the efficiency of the matching process.

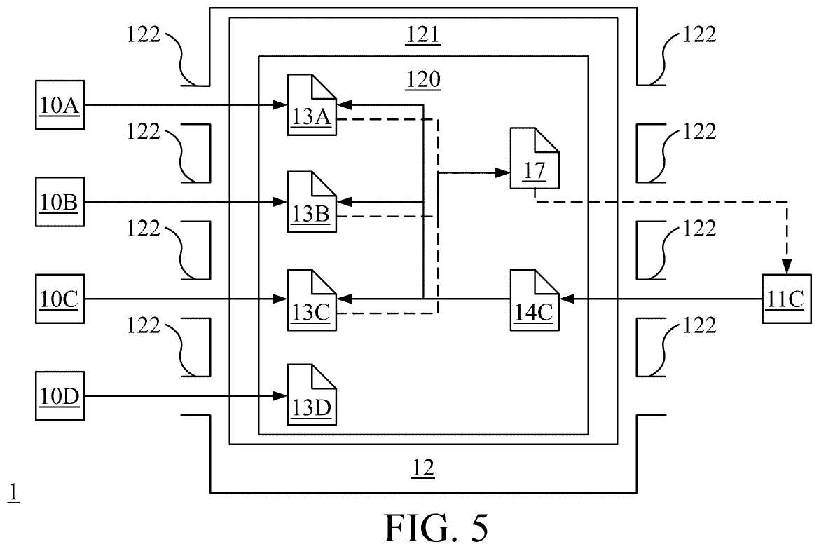

Referring to FIG. 5, in the invite mode, the matching platform 120 obtain the candidate data 14C through another questionnaire. The candidate data 14C may further includes descriptions about a talent prefer tasks, and the matching platform 120 can search the key words generated from the descriptions, so as to choose a plurality of task data.

According to the candidate data 14C, the matching platform 120 choose the task data 13A, 13B, 13C obtained from the request ends 10A, 10B, 10C respectively without choosing the task data 13D from the request end 10D. Then, the matching platform 120 generates a list of recommended tasks 17 according to the chosen task data 13A, 13B, 13C. The list 17 is provided to the bidding end 11C, and the user of the bidding end 11C can choose the task and see if the user of the chosen request end is willing to provide resources and additional data if any, so as to improve the efficiency of the matching process.

In other words, in some embodiments, many talents can list their preferred tasks with descriptions through many bidding ends individually, and the system 1 can acquire many candidate data. After matching, the collaborative nexus device 12 will constantly send potential tasks according to matched task data that each talent would likely to work on until the talent is occupied. In this method, the matching is based on the criteria set by the talents (i.e. bidding ends), and the collaborative nexus device 12 give the talents the opportunity to select.

All or portions of the methods in accordance to the embodiments may be executed in one or more computing devices including server computers, personal computers, laptop computers, mobile computing devices such as smartphones and tablet computers.

The embodiments may include computer storage media, transient and non-transient memory devices having machine instructions stored therein, which can be used to program or configure the computing devices, computer processors, or electronic circuitries to perform any of the processes of the present invention. The storage media, transient and non-transient memory devices can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A collaborative nexus device for solving climate change mitigation and water sustainability, comprising:
a connecting port, connected to a plurality of request ends and a plurality of bidding ends; and
a processor, connected to the connecting port,
wherein the processor obtains at least one task data from the request ends and at least one candidate data from the bidding ends through the connecting port,
wherein the items of the task data include data insights, and the candidate data includes items about skills possessed by an individual or a group of people, and the processor matches these items, and the items are related to climate change mitigation and water sustainability,
wherein the processor provides a collaborative contract to the request end corresponded to the matched task data and the bidding end corresponded to the matched candidate data through the connecting port, and display the collaborative contract on the request end and the bidding end and ask for signatures,
wherein the processor provides a collaborative space to both the matched request end and the matched bidding end, and the both ends display the collaborative space showing information about progress of a task generated from the task data and interface for both input and output.

2. The collaborative nexus device of claim 1, wherein the items related to climate change mitigation and water sustainability comprises:
a plurality of analyses of renewable energy as climate changes;
an analyzing duration; and
a required deadline,
and the analyses comprise availability of renewable energy.

3. The collaborative nexus device of claim 1, wherein the items related to climate change mitigation and water sustainability comprises:
a plurality of river flow data collections of varied locations; and
at least one requirement related to river flow data collection.

4. The collaborative nexus device of claim 1, wherein the items related to climate change mitigation and water sustainability comprises:
at least one visualizing format;
at least one visualizing style; and
at least one language.

5. The collaborative nexus device of claim 1, wherein the items related to climate change mitigation and water sustainability comprises:
at least one carbon footprint analysis method; and
at least one analysis equipment.

6. The collaborative nexus device of claim 1, wherein the items related to climate change mitigation and water sustainability comprises:
at least one fintech domain; and
at least one required fund.

7. The collaborative nexus device of claim 1, wherein the items related to climate change mitigation and water sustainability comprises:
at least one weather prediction period; and
at least one weather prediction location.

8. The collaborative nexus device of claim 1, wherein the collaborative space comprises a task management interface.

9. The collaborative nexus device of claim 1, wherein the collaborative space comprises a data security and protection.

10. The collaborative nexus device of claim 1, wherein the collaborative space comprises a quality control and dispute interface.

11. A system of collaborative nexus for solving climate change mitigation and water sustainability, comprising:
the collaborative nexus device of claim 1;
the request ends; and
the bidding ends,
wherein the collaborative nexus device comprises a matching platform and the collaborative space,
wherein the collaborative nexus device is connected to of the request ends and bidding ends through internet,
wherein the matching platform displays interfaces for input on the request ends and the bidding ends individually, and the collaborative nexus device obtains the task data and the candidate data through the interfaces of the matching platform,
wherein the matching platform matches the items related to climate change mitigation and water sustainability of the task data with the candidate data, and the matching platform provides the collaborative contract,
wherein the collaborative nexus device provides the collaborative space to both the matched request end and the matched bidding end.

12. The system of claim 11, wherein the items related to climate change mitigation and water sustainability comprises:
a plurality of analyses of renewable energy as climate changes;
an analyzing duration; and
a required deadline,
and the analyses comprise availability of renewable energy.

13. The system of claim 11, wherein the items related to climate change mitigation and water sustainability comprises:
a plurality of river flow data collections of varied locations; and
at least one requirement related to river flow data collection.

14. The system of claim 11, wherein the items related to climate change mitigation and water sustainability comprises:
at least one visualizing format;
at least one visualizing style; and
at least one language.

15. The system of claim 11, wherein the items related to climate change mitigation and water sustainability comprises:
at least one carbon footprint analysis method; and
at least one analysis equipment.

16. The system of claim 11, wherein the items related to climate change mitigation and water sustainability comprises:
at least one fintech domain; and
at least one required fund.

17. The system of claim 11, wherein the items related to climate change mitigation and water sustainability comprises:
at least one weather prediction period; and
at least one weather prediction location.

18. The system of claim 11, wherein the collaborative space comprises a task management interface.

19. The system of claim 11, wherein the collaborative space comprises a data security and protection.

20. The system of claim 11, wherein the collaborative space comprises a quality control and dispute interface.
